(19) United States
(12) Patent Application Publication
(10) Pub. No.: US 2014/0081435 A1
(43) Pub. Date: Mar. 20, 2014

(54) Connecting Players to Professional Athletes to Receive Evaluations

(71) Applicant: COACHED BY PROS, LLC, American Fork, UT (US)

(72) Inventor: Jadon Wagner, American Fork, UT (US)

(73) Assignee: Coached BY Pros, LLC, American Fork, UT (US)

(21) Appl. No.: 13/621,545

(22) Filed: Sep. 17, 2012

(51) Int. Cl. G06F 19/00

(52) U.S. Cl. 700/91

(57) ABSTRACT

The present invention extends to methods, systems, and computer program products for connecting players to professional athletes to receive evaluations from the professional athletes regarding the players' abilities within a sport. The present invention can be embodied as a website that allows a player to select one or more participating professional athletes to review video of the player, and receive evaluations from the professional athletes regarding the abilities of the player. In this way, a player can receive an evaluation from an expert at the player's position or role within a sport. Such evaluations can be used by the player to continue improving his abilities, as well as to promote the player to recruiters at higher levels within the sport.

### CROSS-REFERENCE TO RELATED APPLICATIONS

Not Applicable.

### BACKGROUND

Most non-professional athletes, such as high school athletes, desire to improve their athletic abilities. Additionally, many of these athletes are also pursuing an opportunity to continue playing at higher levels within their sport. For example, a high school football player may desire to be recruited to play football at the college level.

For many non-professional athletes (or players), it can be difficult to receive adequate coaching to continue improving their abilities. For example, although coaches of such players often have a general knowledge of the sport, they often lack sufficient experience or knowledge with particular positions or roles within a sport to continue assisting a player beyond a basic level.

It can also be difficult for players to be discovered by recruiters or scouts at a higher level within their sport. In many cases, a player's coach or other mentor assists the player in promoting his abilities to recruiters. However, a recruiter oftentimes does not highly value the opinion of a coach or mentor closely linked to the player. As such, such methods of promoting a player are oftentimes inefficient.

### BRIEF SUMMARY

The present invention extends to methods, systems, and computer program products for connecting players to professional athletes to receive evaluations from the professional athletes regarding the players' abilities within a sport. The present invention can be embodied as a website that allows a player to select one or more participating professional athletes to review video of the player, and receive evaluations from the professional athletes regarding the abilities of the player. In this way, a player can receive an evaluation from an expert at the player's position or role within a sport. Such evaluations can be used by the player to continue improving his abilities, as well as to promote the player to recruiters at higher levels within the sport.

In one embodiment, the present invention includes a method for connecting players to professional athletes to receive evaluations. Profile information of a player of a sport is received at a server computing system. The profile information includes one or more videos of the player playing the sport. The profile information is provided to a first professional athlete in the sport. An evaluation of the player is received from the first professional athlete. The evaluation is based on the first professional athlete viewing the one or more videos of the player playing the sport. The evaluation is then provided to the player.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary computer environment in which the present invention can be implemented;

FIG. 2 illustrates an exemplary home page of a website that can be provided to connect players to professional athletes to receive evaluations;

FIG. 3 illustrates an exemplary request page for generating a request to receive an evaluation;

FIG. 4 illustrates an exemplary approval page that can display professional athletes that are available to provide evaluations;

FIG. 5 illustrates an exemplary profile page for a player;

FIG. 6 illustrates an exemplary evaluation page that can be displayed to a professional athlete to perform an evaluation of a player;

FIG. 7 illustrates an exemplary finished evaluation page that can display a finished evaluation provided by a professional athlete; and

FIG. 8 illustrates a flowchart of an exemplary method for connecting players to professional athletes to receive evaluations.

### DETAILED DESCRIPTION

The present invention extends to methods, systems, and computer program products for connecting players to professional athletes to receive evaluations from the professional athletes regarding the players' abilities within a sport. The present invention can be embodied as a website that allows a player to select one or more participating professional athletes to review video of the player, and receive evaluations from the professional athletes regarding the abilities of the player. In this way, a player can receive an evaluation from an expert at the player's position or role within a sport. Such evaluations can be used by the player to continue improving his abilities, as well as to promote the player to recruiters at higher levels within the sport.

In one embodiment, the present invention includes a method for connecting players to professional athletes to receive evaluations. Profile information of a player of a sport is received at a server computing system. The profile information includes one or more videos of the player playing the sport. The profile information is provided to a first professional athlete in the sport. An evaluation of the player is received from the first professional athlete. The evaluation is based on the first professional athlete viewing the one or more videos of the player playing the sport. The evaluation is then provided to the player.

Embodiments of the present invention may comprise or utilize special purpose or general-purpose computers including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

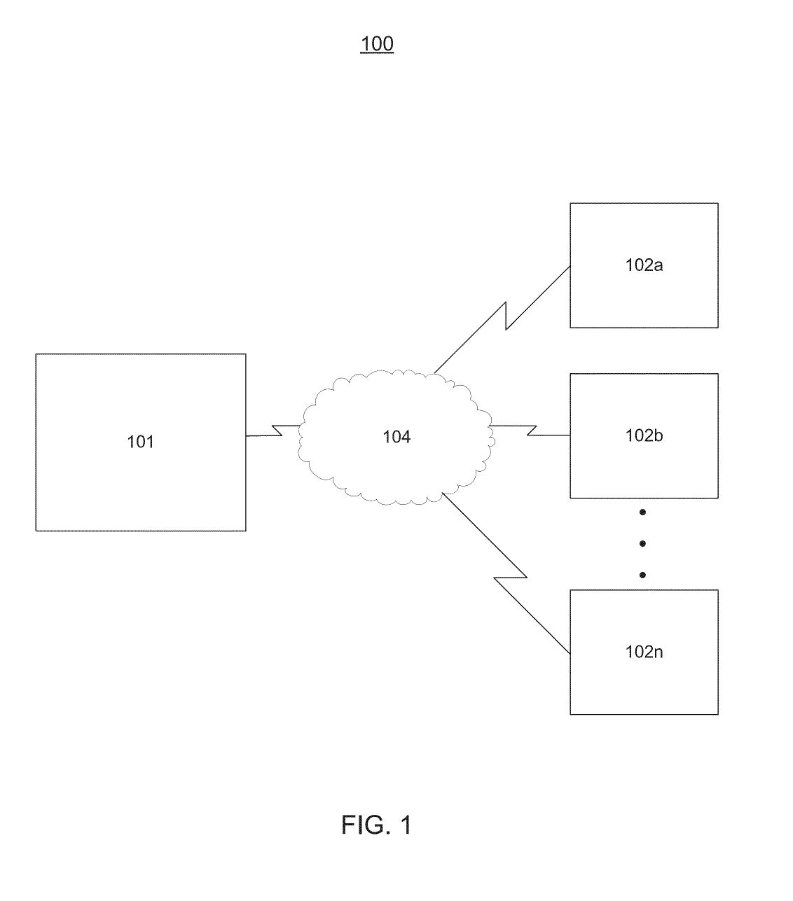

FIG. 1 illustrates an exemplary computer environment 100 in which the present invention can be implemented. Computer environment 100 includes server system 101 and client computing devices 102a-102n which are connected via a network 104. In a typical implementation of the present invention, server system 101 provides a website which client computing devices 102a-102n access over the internet.

Server system 101 can comprise any number of computer systems or resources. For example, server system 101 can be a single server computing system, or can be a cloud of computer resources.

Client computing devices 102a-102n can represent any type of computing device capable of communicating with server system 101 over network 104. Examples of client computing devices 102a-102n include desktop computers, laptop computers, tablets, mobile phones, etc. As described below, server system 101 can provide a website that is accessed by players and professional athletes using any number of client computing devices 102a-102n.

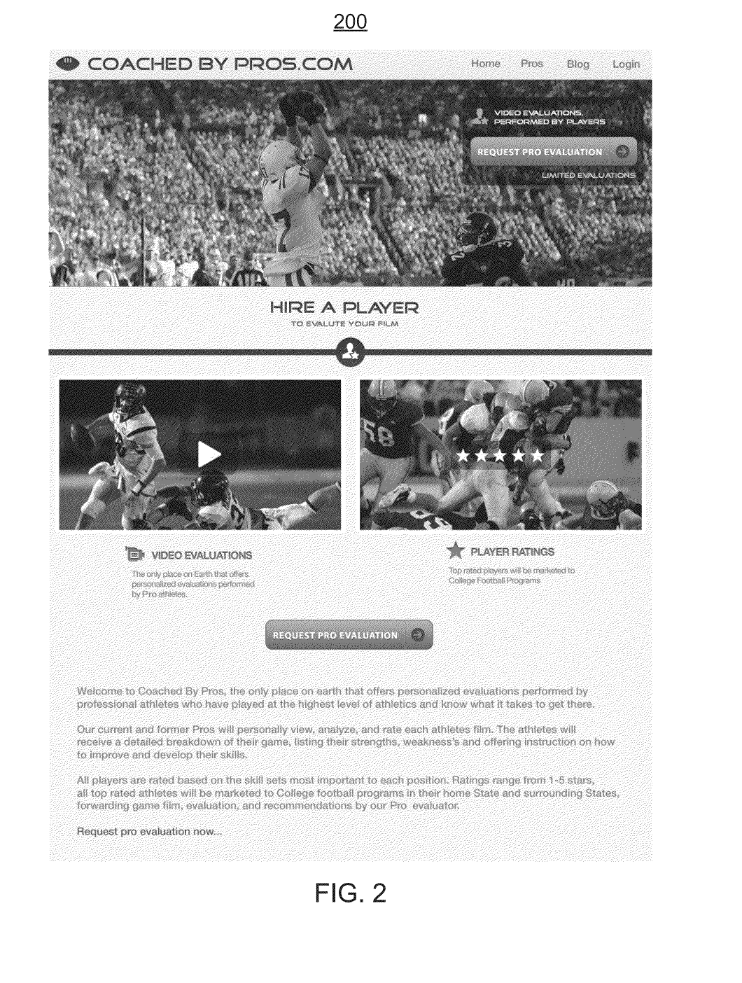

FIG. 2 illustrates an exemplary home page 200 of a website that can be provided by server system 101 to connect players to professional athletes to receive evaluations. As shown on home page 200, a player can submit information regarding the player's abilities to the website, and then request an evaluation of the information by a professional athlete. Examples of the type of information that can be provided include a player's profile, statistics, awards and honors, and videos.

The following description uses an example of a high school football player submitting information for evaluation by a professional football player. However, the present invention can equally be used to provide evaluations to players of any sport (e.g. basketball, baseball, hockey, etc).

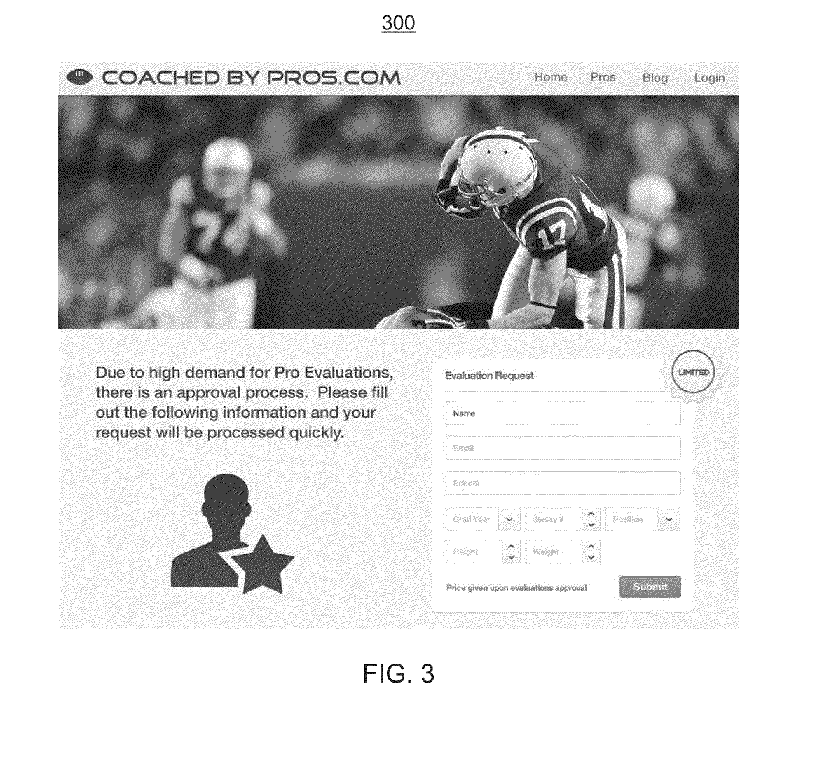

When a player requests a pro evaluation on home page 200 (e.g. by selecting the request pro evaluation button or another link), the request page 300 of FIG. 3 can be displayed. On request page 300, the player is requested to enter his name, contact information, and other information relevant to the sport for which the evaluation is being requests. In this example, the player is a high school football player, and therefore, the player is also requested to provide his school, graduation year, grade point average (GPA), jersey number, position, height, or weight. In other sports, different information may be relevant. Accordingly, request page 300 can be customized based on the sport for which the evaluation is being requested. For example, request page 300 can include a field for specifying a sport. Once a sport is selected, request page 300 can be updated to include fields pertaining to the selected sport.

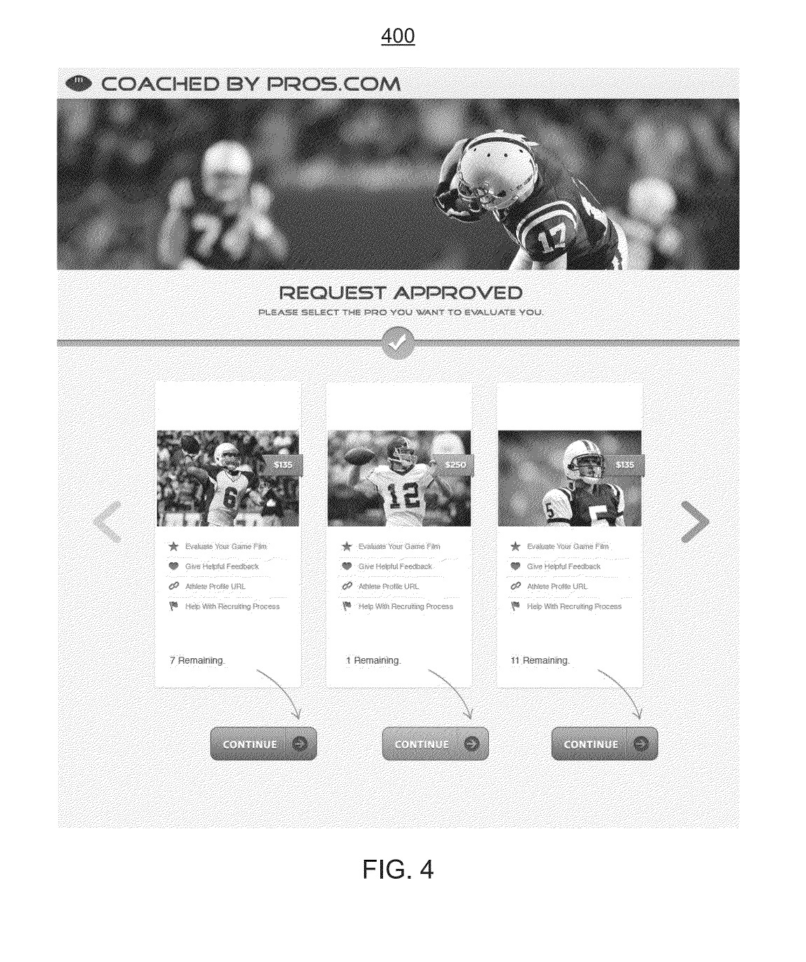

Once the player submits the information supplied to request page 300, the information can be used to identify professional athletes that are available to provide an evaluation. Available professional athletes can be determined based on the sport selected, the position selected, or any other criteria. As shown in approval page 400 in FIG. 4, the player has specified that he is a quarterback, and therefore, the available professional athletes include professional quarterbacks.

Approval page 400 can also display the cost of requesting an evaluation from each available professional athlete. Approval page 400 can also display what services will be included in the evaluation. For example, an evaluation can include one or more services including the evaluation of player film, helpful feedback, a custom profile webpage, and assistance with recruiting. In FIG. 4, the evaluation provided by each of the three depicted available professional quarterbacks includes the four stated services. However, in some embodiments, an evaluation by a particular professional athlete may provide fewer or more services then is depicted in FIG. 4.

In some embodiments, approval page 400 can also display a professional athlete's availability to provide evaluations. The availability can be based on a number of evaluations the professional athlete has agreed to provide such as a quota for a specified time period (e.g. 10 evaluations per week). As shown in FIG. 4, the first professional athlete has availability to perform 7 evaluations, the second professional athlete has availability to perform 1 evaluation, and the third professional athlete has availability to perform 11 evaluations. When availability is based on a quota per time period, the availability count can be reset at the beginning of each time period.

Once the player selects a professional athlete to perform an evaluation, an evaluation request is sent to the selected professional athlete. The status of the evaluation request can be determined based on whether the player has submitted all the required information. For example, if the evaluation includes analysis of the player's video, but the player has not yet submitted videos, the evaluation request can have a status of pending. In some embodiments, the evaluation request is not sent to the selected professional athlete until all necessary information has been received.

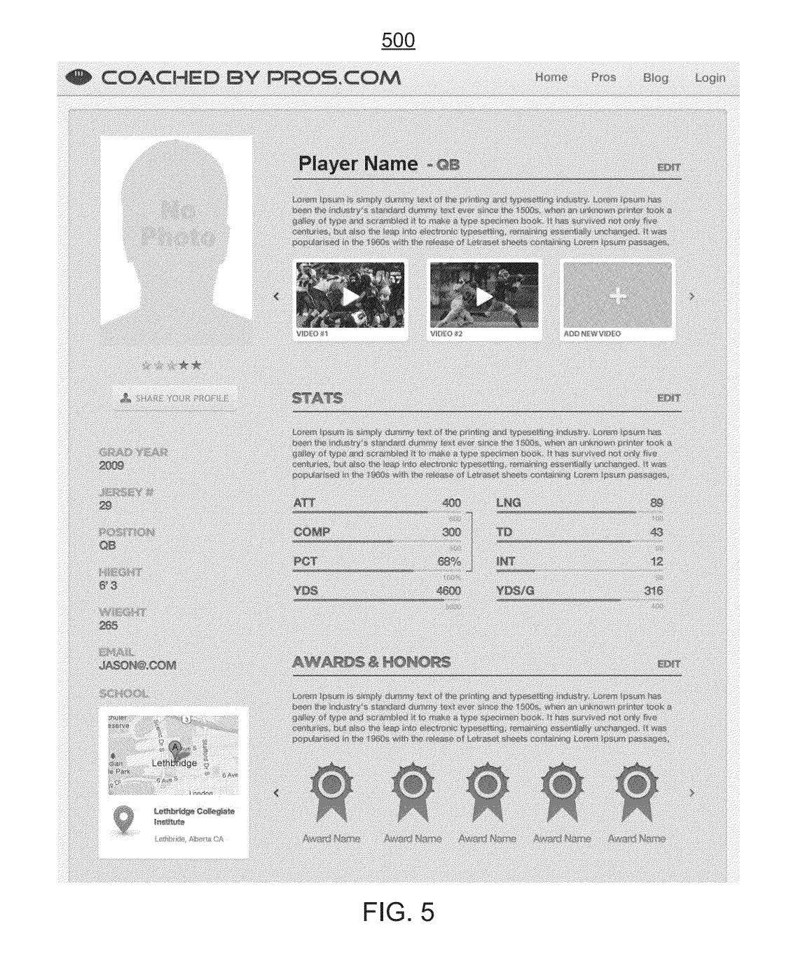

FIG. 5 illustrates an exemplary profile page 500 for a player. Profile page 500 can include the information submitted by the player to request page 300. Profile page can also include a photo, a rating, videos, statistics, awards and honors, or other information of the player. Profile page 500 can also provide an option to add or edit any of the player's information. For example, profile page 500 can provide an option to upload videos (e.g. game film) to the profile. In some embodiments, an option can also be provided for specifying which videos the player desires the professional athlete to review (such as when the player has uploaded more videos to his profile than an evaluation will consider).

The statistics that are provided on profile page 500 can be based on the position and sport of the player. In FIG. 5, the profile represents a quarterback. As such, the statistics include those relevant to the quarterback position in football such as attempts (ATT), completions (COMP), percentage of completions (PCT), yards (YDS), etc. In some embodiments, the player can be provided the option to select which statistics are displayed within the profile, while in other embodiments, the displayed statistics can be determined based on the sport and position played.

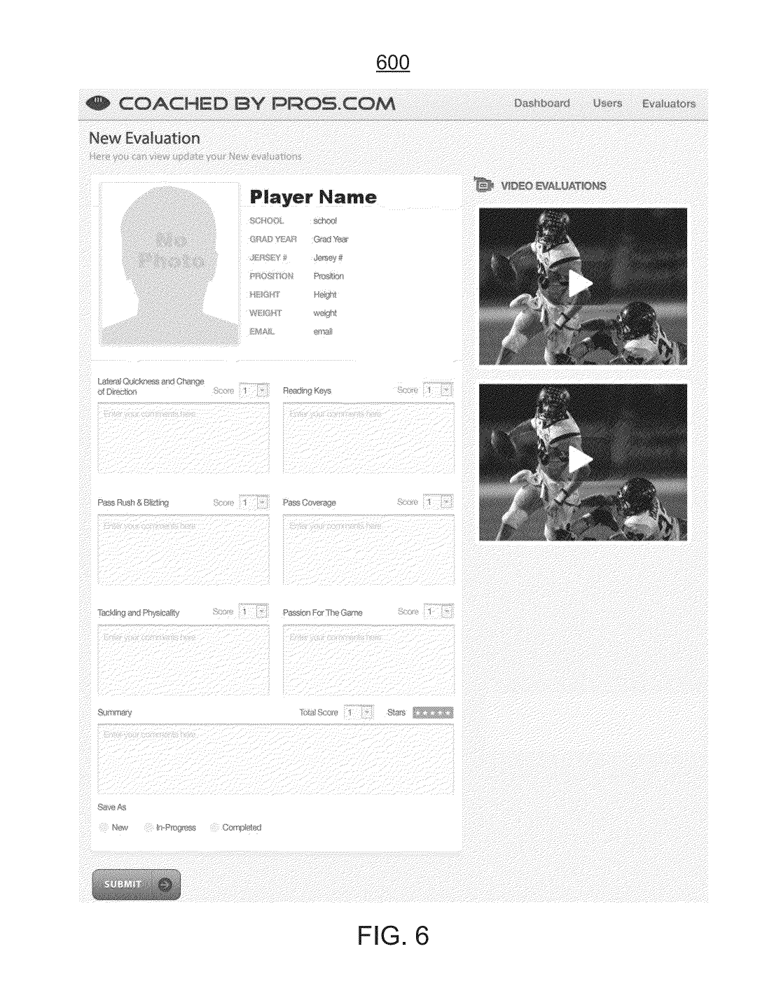

FIG. 6 illustrates an evaluation page 600 that can be displayed to a professional athlete to perform an evaluation of a player. Evaluation page 600 can display profile information of the player (e.g. name, school, graduation year, position, GPA, etc.), as well as one or more videos that the professional athlete is to evaluate. Evaluation page 600 can also display various fields for providing feedback in various areas.

The feedback can include a score for the area and any comments the professional athlete may have. A total of these scores, a rating, and/or a summary can also be provided. In some embodiments, the feedback can include links to content (e.g. text, photos, videos, etc.) providing guidance for improving in a particular area (e.g. coaching). For example, if the professional athlete identified that the player can improve his throwing motion, a link to a video teaching proper throwing motion can be provided in the feedback.

In some embodiments, the feedback can also include personal video commentary by the professional athlete. For example, evaluation page 600 can allow the professional athlete to submit or record video feedback to be included in the evaluation.

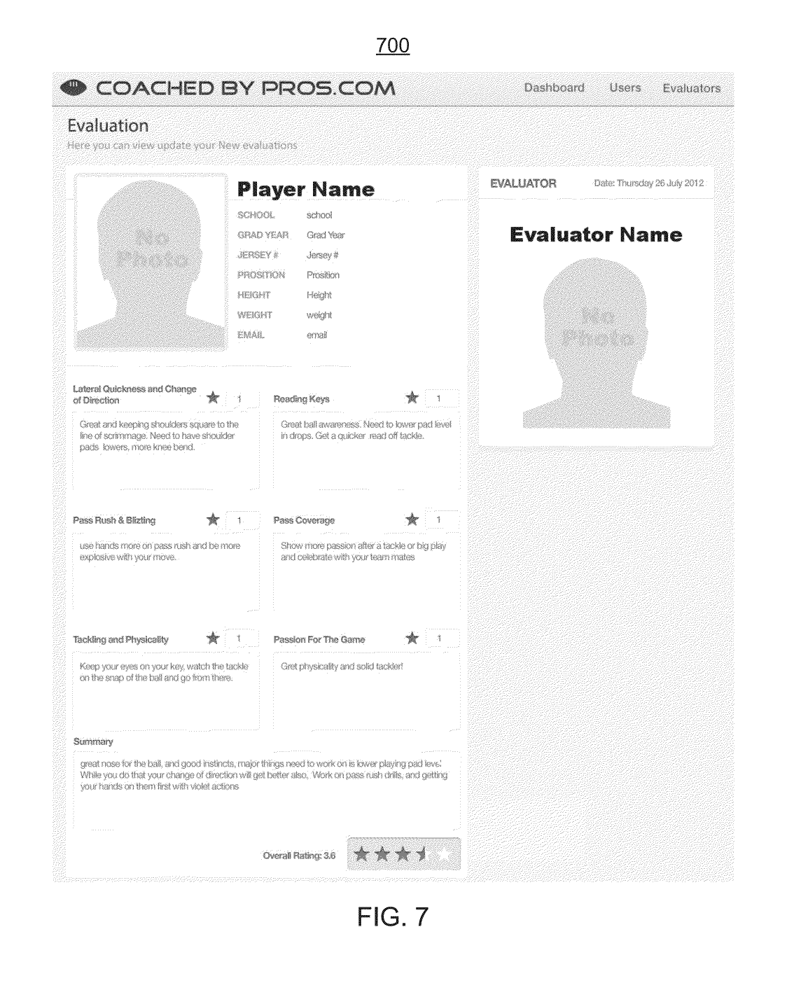

FIG. 7 illustrates an exemplary finished evaluation page 700. Finished evaluation page 700 is similar to evaluation page 600 with the addition of evaluator information (e.g. the professional athlete's name and picture), and the feedback provided by the evaluator. As shown, the evaluation can include an overall rating, which in FIG. 7 is depicted as a rating from 1 to 5 stars. This overall rating can be based on the scores provided by the professional athlete for the various areas in the evaluation.

In some embodiments, when a professional athlete completes an evaluation, the evaluation can be reviewed prior to providing the evaluation to the player. For example, the professional athlete can submit an evaluation to the website to allow the website (e.g. an employee of the website) to review the evaluation to ensure that it meets specified guidelines.

In any case, an evaluation can be provided to a player via the player's profile on the website. In some embodiments, the profile page 500 can directly display the evaluation or provide one or more links to the evaluation. In some embodiments, profile page 500 and/or any evaluations the player has received can be provided at a player specific URL thus facilitating the sharing of the player's information with third parties.

Profile page 500 or another page for displaying evaluations can be accessible via a web browser to allow the player to share his profile and evaluations with others including recruiters. In cases where the player has received multiple evaluations (e.g. by requesting evaluations from multiple professional athletes or multiple evaluations by the same professional athlete), each evaluation can be provided on or accessible from profile page 500.

In some embodiments, the website can provide a service for promoting players to recruiters or scouts (e.g. of a college football team). Players that receive higher ratings in evaluations from professional athletes can be promoted to such recruiters. Because the rating is based on an evaluation of a professional athlete, which in most cases plays the same position as the player, the rating can be highly trusted by recruiters.

Accordingly, in some embodiments, the website of the present invention includes functionality for identifying players of interest to a third party and for routing profile information of the identified players to the third party. In cases where a player has received multiple evaluations, the website can include functionality for selecting a most recent evaluation, or weighting evaluations based on specified criteria. For example, one professional athlete's evaluations may be weighted more heavily than those of another professional athlete. Such may be the case if one professional athlete has shown a greater ability to accurately rate a player. Similarly, a more recent evaluation can be weighted differently than a less recent evaluation.

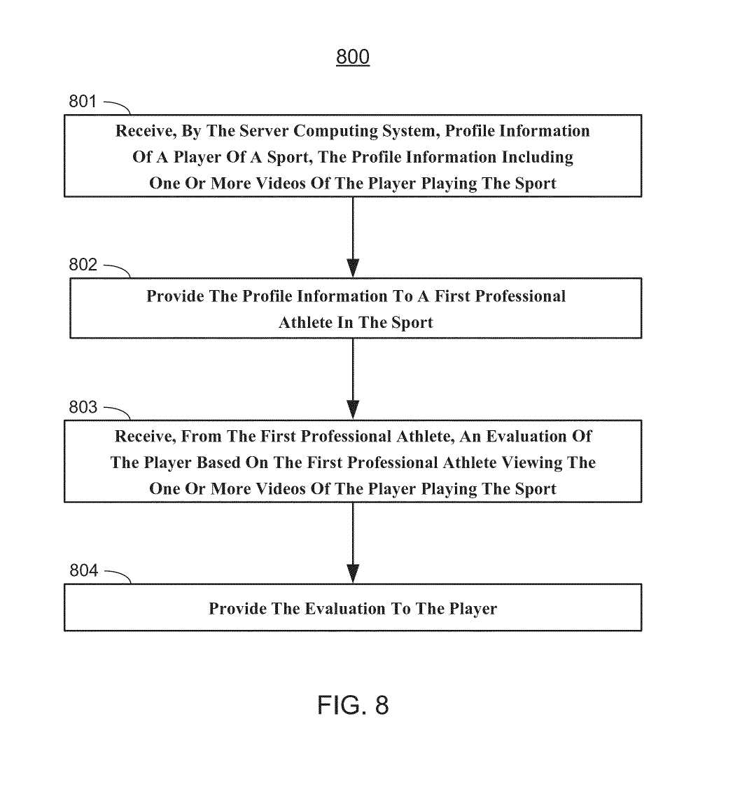

FIG. 8 illustrates a flowchart of an exemplary method 800 for connecting players to professional athletes to receive evaluations. Method 800 will be described with reference to the Figures. Method 800 can be implemented by server computing system 101 in the form of a website.

Method 800 includes an act 801 of receiving, by a server computing system, profile information of a player of a sport. The profile information includes one or more videos of the player playing the sport. For example, the player can provide profile information to the website via request page 300 and/or profile page 500.

Method 800 includes an act 802 of providing the profile information to a first professional athlete in the sport. For example, the profile information can be displayed within a webpage, such as evaluation page 600, to the first professional athlete (e.g. via one of client computing devices 102a-102n).

Method 800 includes an act 803 of receiving, from the first professional athlete, an evaluation of the player. The evaluation is based on the first professional athlete viewing the one or more videos of the player playing the sport. For example, the one or more videos can be displayed within evaluation page 600 for review by the first professional athlete who then provides an evaluation of the player's performance in the one or more videos.

Method 800 includes an act 804 of providing the evaluation to the player. For example, the content of the evaluation can be provided to the player via profile page 500 or via another webpage or other online format (e.g. email).

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A method, performed by a server computing system, for connecting players to professional athletes to receive evaluations, the method comprising:
receiving, by the server computing system, profile information of a player of a sport, the profile information including one or more videos of the player playing the sport;
providing the profile information to a first professional athlete in the sport;
receiving, from the first professional athlete, an evaluation of the player based on the first professional athlete viewing the one or more videos of the player playing the sport; and
providing the evaluation to the player.

2. The method of claim 1, further comprising:
displaying, to the player, a plurality of professional athletes that are available to provide an evaluation; and
receiving, from the player, a selection of the first professional athlete to perform the evaluation.

3. The method of claim 2, wherein the profile information includes a position in the sport played by the player, and wherein each the plurality of professional athletes that are available to provide an evaluation are selected to be displayed to the player based on a position that the professional athlete has played in the sport at a professional level.

4. The method of claim 3, wherein the position that the professional athlete has played is the same as the position played by the player.

5. The method of claim 2, wherein the availability of a professional athlete to provide an evaluation is based on a number of evaluations the professional athlete has provided during a specified time period.

6. The method of claim 1, wherein the profile information further comprises one or more of:
the player's school;
the player's graduation date;
the player's height;
the player's weight;
the player's position in the sport;
the player's jersey number; or
the player's grade point average.

7. The method of claim 1, further comprising:
generating, by the server computing system, a profile page from the player, the profile page including the profile information, the profile page further providing access to the evaluation.

8. The method of claim 7, wherein the profile page further includes statistics of the player.

9. The method of claim 1, wherein the evaluation includes feedback for a plurality of areas of the sport.

10. The method of claim 1, wherein the evaluation includes a score for a plurality of areas of the sport.

11. The method of claim 1, wherein the evaluation includes a rating for the player.

12. The method of claim 11, wherein the rating is based on a score for a plurality of areas of the sport.

13. The method of claim 1, wherein the profile information includes a position in the sport played by the player, and wherein providing the profile information to a first professional athlete in the sport further comprises:
generating an evaluation form that includes a plurality of areas relevant to the position played by the player, and user interface elements for providing feedback for each of the plurality of areas.

14. The method of claim 13, wherein the feedback further includes a score for each of the areas.

15. The method of claim 13, wherein the evaluation form further includes one or more user interface elements for providing a rating for the player.

16. The method of claim 13, wherein the feedback further includes video commentary of the first professional athlete.

17. The method of claim 13, wherein the feedback further includes links to instructional content regarding a particular area in which the first professional athlete determined the player can improve.

18. The method of claim 1, wherein the evaluation includes a rating of the player, the method further comprising:
determining that the rating exceeds a specified threshold; and
providing the evaluation of the player to a recruiter at a higher level of the sport based on the rating exceeding the specified threshold.

19. The method of claim 18, wherein the specified threshold comprises a percentile rank of the rating against ratings of all players of the position that have received evaluations.

20. A computer storage media storing computer executable instructions which when executed implement a website for connecting players to professional athletes to receive evaluations, the website implementing a method comprising:
receiving profile information of a player of a sport, the profile information including one or more videos of the player playing the sport, and a position that the player plays in the sport;
identifying one or more professional athletes that have played the position at the professional level;
displaying the identified one or more professional athletes to the player;
receiving, from the player, a selection of a first of the one or more professional athletes;
generating an evaluation form that includes the one or more videos of the player, and a plurality of areas relevant to the position for which the first professional athlete is to provide feedback;
sending the evaluation form to the first professional athlete, including displaying the one or more videos to the first professional athlete;
after the one or more videos have been displayed to the first professional athlete, receiving, from the first professional athlete, feedback based on the player's performance in the one or more videos, the feedback analyzing the player's performance in the plurality of areas;
generating an evaluation from the feedback; and
displaying the evaluation to the player.
